(19) United States
(12) Patent Application Publication
(10) Pub. No.: US 2022/0118873 A1
(43) Pub. Date: Apr. 21, 2022

(54) Electric Vehicle Battery Power Extender

(71) Applicant: Gregory D'Oliveira Henry, West Orange, NJ (US)

(72) Inventor: Gregory D'Oliveira Henry, West Orange, NJ (US)

(21) Appl. No.: 17/074,531

(22) Filed: Oct. 19, 2020

(51) Int. Cl. B60L 53/52; B60L 8/00; H02J 7/00; H02J 7/14; B60L 53/65

(52) U.S. Cl. CPC B60L 53/52; B60L 8/006; B60L 53/65; H02J 7/1476; H02J 7/1438; H02J 7/007188

(57) ABSTRACT

This invention provides an enhanced electric vehicle battery powering and recharging system technology, particularly when the vehicle is moving or when wind or air comes in contact with the vehicle wind-power electric generator propeller system. The invention can be installed in partial or fully electric land, air, or water vehicles, to power or recharge the vehicle's battery system. This invention will extend a vehicle's travel distance before or without stopping and connecting to fossil fuel or other stationary rechargeable power sources. The vehicle's wind-powered electric generator invention is an additional battery charging technology that will support any partial or fully electric-powered vehicle. The invention can be installed in a partial or fully electric-powered vehicle as a hardware component and software program, without any interferences with existing vehicle electric battery charging systems.

### PRIORITY

This application does not claims any domestic benefit from pending provisional application.

### FIELD OF INVENTION

The present invention relates to the field of battery charging system for electric vehicles, specifically for wind powered electric charging system for extending the storage power in a fully or partial electric vehicle battery system for longer distance and travel time.

### BACKGROUND

Every year government is constantly looking for ways to tackle vehicle fuel emission. By 2025 it is predicted that 30% of the vehicle sales will be of partial or fully electric powered vehicles. The main challenge is to create electric vehicles that can travel longer distances without needing to be stopped for a recharge from a stationary power source that may be powered by a fossil fuel powering system ever so often.

Adding a new advance vehicle wind powered electric charging system would be very beneficial to the existing and future partial or fully electric powered vehicles. This is specifically for the extension of the travel distance before the vehicle needed to be stopped and be connected to a power source for a recharge. A method for an vehicle wind powered electric charging system to allow for a partial or fully electric powered vehicle to travel at a longer distance without the need to stop for recharge has been addressed in more than one prior patents. However, those prior patents are recognized as methods of a braking mechanism. Current partial or fully electric powered vehicle battery charging technology designs and functions may be very useful, but are not implemented in the most efficient manner. This new invention will solve that problem, because of its application and its minimal to no resistance on the vehicle drive functions.

U.S. Pat. No. 8,860,362 discloses the use of a system for charging a battery within a partially electric vehicle. U.S. Pat. No. 5,635,817 discloses an emergency vehicle battery charging device is utilized to charge a depleted battery of a first vehicle from the engine system of a running second vehicle at a determined maximum charging current above that use for a trickle charge and below the typical starting current of either vehicle.

There are also other partial or fully electric powered vehicle battery charging technologies which are disclosed in U.S. Pat. Nos. 5,487,956 and 8,009,844. These prior art patents disclose technologies that are relevant to the current invention, which presents a unique combination of several existing technologies.

Some of these existing devices and/or technologies that are implemented in current inventions include: Propeller or propeller drive, assemblies and propeller blade retention assembly (U.S. Pat. Nos. 7,886,544, and 9,957,038); Electrically powered motor vehicle with linear electric generator and Electric power generation control device for motor vehicle (U.S. Pat. Nos. 5,788,003 and 8,143,741); Charging module and rechargeable battery assembly for electric vehicle and System and method for recharging electric vehicle batteries (U.S. Pat. Nos. 9,543,783 and 8,587,253); Electrical wiring harness structure for vehicle (U.S. Pat. No. 5,623,169);

### SUMMARY OF THE INVENTION

The invention herein present new enhancement features of known technologies. The invention works across existing platforms of partial or fully electric powered vehicles. The invention utilizes existing battery charging technologies to charge internal electric vehicle battery system. Components and features of the partial or fully electric powered vehicle battery charging system, charges the battery only as required by the vehicle internal battery. The vehicle wind powered electric charging system can be added to a partial or to a fully electric powered vehicle battery charging systems.

The present invention represents a dynamic improvement to existing partial or fully electric powered vehicle battery charging technologies. The invention utilizes standard battery charging technologies. This new technology allows a partial or fully electric powered vehicle battery to be recharge without stopping for a recharge from stationary fossil fuel or from other power source. An advantage of this new vehicle wind powered electric charging system is a means to reduce the usages of fossil fuel to recharge the electric vehicle battery system.

This new wind powered electric partial or fully electric powered vehicle charging system is brought about by the application of an additional advance vehicle battery recharging technical features. These features are designed to be installed and operate with existing battery technologies in a partial or a fully electric powered vehicle. The new wind or air powered partial or fully electric powered vehicle charging process is initiated by the movement of the vehicle. The movement of wind or air causes the rotation of the wind electric generator propeller. This rotation of the generator propeller then causes a generation of electric power for the purpose of recharging the existing electric vehicle battery system.

A preferred embodiment of the invention utilizes conventional electricity generation and charging electronic circuitry, which operates through the movement of wind or air. This new invention of a partial or fully electric vehicle charging system will be activated by the movement of wind or air on the new vehicle electric generator charging system propeller. This vehicle wind or air powered electric vehicle charging system will allow the vehicle battery to charge and recharge as is known in the art.

Allowing the battery system in a partial or fully electric powered vehicle with a wind powered electric generator to recharge the vehicle batteries, for the purpose of longer travel distances. This new automobile battery charging system will prevent the electric powered vehicle from being connected to a fossil fuel generating power source. Similarly, the electric vehicle wind powered generating system will help to reduce the increase of dangerous green house gas, and promote a safer carbon foot print in our environment. The electric vehicle with a wind powered generator can recharge the batteries in an electric vehicle which will also reduced the need for the use of stationary fossil fuel power system, unless absolutely necessary.

For a partial or fully electric powered vehicle which does not have this new wind powered electric generator system installed by the vehicle manufacturer. The system will be able to be installed by qualified after manufacturer vehicle electronic installer. This will allow partial or fully electric vehicles manufactured prior to the implementation of this new invention to take advantage of this carbon foot print and green house gas reduction technology. This aftermarket installation of the new partial or fully electric vehicle with a wind powered generating system. This process for recharging the electric vehicle batteries can prevent the rapid recycling of prior partial or fully electric vehicles, unless it is absolutely necessary.

The software for this new invention partial or fully electric powered vehicle with a wind electric generation system, if applicable will include advanced security encryption features, to prevent unauthorized access by unauthorized user systems. Advance security features are desirable, because as the new electric vehicle battery charging technology is designed to be used in conjunction with other existing vehicle battery charging technologies, security software will be vital.

### BRIEF DESCRIPTION OF THE DRAWINGS

FIG. 1 is a block diagram of the present invention.

### DETAILED DESCRIPTION OF THE PREFERRED EMBODIMENT

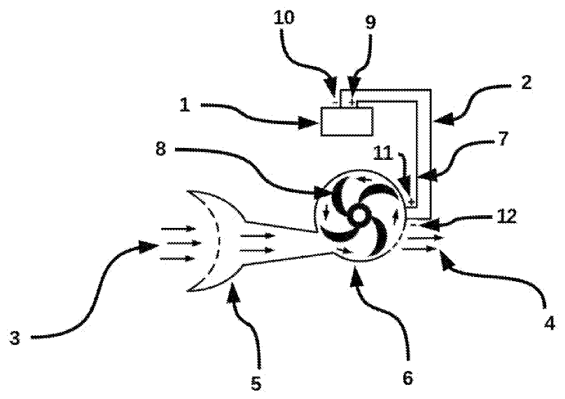

In FIG. 1 the electric vehicle battery range extending system contains the wind or air component 3, where the wind or air component 3 entering through the inlet of device 5. Inlet device 5 the pathway for the wind or air to the propeller of the electric generating device 8, where the propeller of electric generating system device 8 causes the electric power generator device 6, where the transmission of electric power flows through connecting wiring devices 2 and 7. The negative wire connection device 2, and the positive wire connection device, which are the connection leads to object 1, the existing electric vehicle battery system. The negative wire terminal device 12, from the wind electric generator device 6 connecting to device 10, the existing vehicle battery device 1. The positive terminal 11, from the wind electric generator device 6 connecting to the positive wire terminal device 9, of the existing electric vehicle battery device 1. The wind or air object 3 exit through object 4, which is the excess wind or air exhaust port. Once the electric vehicle is moving, the wind or air flow will cause the propeller of the vehicle wind electric power generator to rotate. Then the generated electric power will then be transmitted through the connection leads as a means for charging the existing electric vehicle battery system. The battery power will then be use to operate the moving electric vehicle for a longer travel time period before needing to be stopped and connected to a fossil fuel electric or other external charging sources. This electric powered vehicle existing or future could be of either land, air or water.

Once the new wind powered electric vehicle battery power extender FIG. 1 is installed on a land, air or water vehicle, and the vehicle is moving then object 3, the wind will cause object 8, the wind propeller to rotate, then object 6 the wind power electric generator will generate electricity and then transmit the electricity over the negative wire connection of object 2 and the positive wire connection of object 7, to the vehicle existing battery for charging object 1, the existing electric vehicle battery, then the wind or air of object 3 will be exhausted through object 4, the wind generator exhaust port. Once the vehicle is moving and vehicle existing battery is charging, the vehicle will then be able to travel longer on the constant charge from the wind electric power generator 6, causing the vehicle to use less fossil fuel or stop for recharging during travel. This will leads to a tremendous reduction in greenhouse gas and other known environmental pollution.

Using the wind electric power generating device 6, the moving vehicle can obtain sustainable electric power to the existing electric vehicle battery device 1 to sustain the vehicle travel distance. A great sustainable and economical way for powering a land, air or water vehicle.

The vehicle wind electricity generating device 6 comprises of an inlet device 5. Electricity generation device 6 is preferably equipped with advance wind and temperature sensing system for the optimal operation of the wind electric power generating system.

The inventive device will be constructed from existing materials, components, and with readily available technologies. The cost is predicted to be of minimal value.

Advantages of the present invention include: electric power generation cause by the wind or air whenever an equipped electric vehicle is moving, greater vehicle travel distance and a reduction for the use of fossil fuel for electric vehicle battery recharging, and also a reduction to greenhouse gas emission and other environmental pollution.

While certain novel features of the present invention have been shown and described therein, it will be understood that various omissions, substitutions and changes in the forms and details of a finished device illustrated and in its operation can be made by those skilled in the art without departing from the spirit of the invention.

I claim:

1. A method for the charging of a future or existing battery system in partial or fully electric powered vehicle with a wind electric power generation system installed in land, air or water vehicle, the method comprising:
Generation of a first electric vehicle power from the wind electric power generator from the movement of the equipped vehicle or wind on a propeller.
identification of a vehicle utilizing the wind electric power generation battery charging or powering technology.
identification of the electric vehicle utilizing a wind electric power generator wind or air inlet.
movement of wind or air for the rotation of the propeller of the vehicle wind electric power generator.
electric power from the vehicle wind electric power generator to power the electric vehicle existing battery system.
electricity from the vehicle wind electric power generator is transmitted over wire connections;
wind or air will be exhausted through the vehicle wind electric power generation exhaust port.
generated wind electric power will power the electric vehicle battery to travel for longer duration without stopping for battery recharging.

2. The method of claim 1, further comprising:
electricity generation by the movement wind or air on the electric vehicle for the main purpose of powering or recharging of the existing electric vehicle battery.

3. The method of claim 1, where the vehicle wind power electricity generation is caused by the movement of the equipped electric vehicle and continues in progress until the vehicle comes to a stop or until the generator propeller stop rotating.

4. The method of claim 1, where the generation of the first vehicle wind electric power from the movement of the electric vehicle comprises of an electricity generation and transmission to an existing electric vehicle battery system.

5. The method of claim 1, further comprising:
Using an inlet for wind or air on the electric vehicle, mainly for powering, charging and extending the battery electric power and travel distance of the electric vehicle.

6. A system for allowing an electric vehicle to receive electric power from a vehicle wind electric power generation system comprising:
a wind electric power generator and a existing or future electric vehicle battery powering system, the vehicle wind electric power generator is capable of generating and transmitting electric power to the electric vehicle existing or future battery power system.
software and hardware for function of the vehicle wind electric powering system;
advance sensors and monitoring technologies implemented as a major feature to in the functioning of the vehicle wind power electricity generating system.
after wind or air entered through the inlet and made contact with the vehicle wind electric power generator propeller causing it to rotate, the electric power will then be generated and transmitted to the electric vehicle existing battery system as a means of recharging the battery.
a constant generation of vehicle electric power will be in progress. Termination of the electric vehicle battery recharging power will happen once the vehicle wind electric power generator propeller stop rotating.
connection of the new vehicle wind electric power generating system to the existing electric vehicle battery system will improve the storage capabilities of the electric vehicle battery system.
connection to the existing electric vehicle battery system will be just as other vehicle battery charging systems are connected without any disruption to the any function of the existing electric vehicle battery power system.
